(19) United States
(12) Patent Application Publication
(10) Pub. No.: US 2022/0315712 A1
(43) Pub. Date: Oct. 6, 2022

(54) METHOD FOR PREPARING STRUCTURED POLYMERS IN POWDER FORM BY THE GEL PROCESS

(71) Applicant: SPCM SA, Andrezieux Boutheon (FR)

(72) Inventors: Aurélien DUCHADEAU, Andrezieux Boutheon (FR); Bruno TAVERNIER, Andrezieux Boutheon (FR); Sébastien COCCOLO, Andrezieux Boutheon (FR); Cédrick FAVERO, Andrezieux Boutheon (FR)

(73) Assignee: SPCM SA, Andrezieux Boutheon (FR)

(21) Appl. No.: 17/596,075

(22) PCT Filed: May 7, 2020
(86) PCT No.: PCT/FR2020/050760

§ 371 Date: Dec. 2, 2021

(30) Foreign Application Priority Data
Jun. 5, 2019 (FR) 1905973

(51) Int. Cl. C08J 3/12; C08F 2/32; C08F 220/56; C08F 4/04

(52) U.S. Cl. CPC C08J 3/12; C08F 2/32; C08F 220/56; C08F 4/04; C08F 2438/03; C08J 2333/26

(57) ABSTRACT

This invention relates to a method for preparing a structured water-soluble polymer having a weight average molecular weight greater than 1 million Daltons and a Huggins Coefficient K_{H} greater than 0.4,
the method comprising the following successive steps:
a) Preparing a polymer, in the form of a gel, by free-radical polymerization in aqueous solution at an initiation temperature between −20° C. and +50° C. of at least one water-soluble monounsaturated ethylenic monomer,
the total weight concentration of monomer(s) in relation to the polymerization charge being between 10 and 60%;
b) Granulating the resulting polymer gel;
c) Drying the polymer gel to obtain a polymer in powder form;
d) Grinding and sifting the powder;
at least 10% by weight of water-soluble polymer, based on the total weight of the water-soluble monounsaturated ethylenic monomer or monounsaturated ethylenic monomers used in step a), being added during the polymerization step a) and optionally during the granulation step b),
the water-soluble polymer being structured and added as a water-in-oil inverse emulsion or dispersion in oil.

### FIELD OF THE INVENTION

This invention relates to a method for the preparation of structured high molecular weight synthetic water-soluble polymers in powder form for use as flocculants or thickeners in multiple applications. More precisely, the invention has as its subject-matter a gel method for obtaining structured water-soluble synthetic polymers of high molecular weight.

### PRIOR ART

High molecular weight synthetic water-soluble polymers are commonly used for many applications due to their flocculating or thickening properties. Indeed, these polymers are of use in the oil and gas industry, hydraulic fracturing, papermaking processes, sludge dewatering, water treatment, construction, mining, cosmetics, agriculture, textile industry and detergents.

By way of example, the flocculant character of these high molecular weight water-soluble synthetic polymers is exploited in the field of water treatment/sludge dewatering. Indeed, after an optional coagulation step where the colloidal particles of a given water (similar to spheres of a size less than 1 micrometer) are destabilized, flocculation represents the step where the particles are gathered in aggregates of high molecular weight. to generate rapid sedimentation. The water-soluble polymers thus used for the treatment of water are mainly in the form of powder or water-in-oil inverse emulsion. Depending on the water to be treated, the physical properties of the flocculant are modulated. Thus, it is possible to adapt the ionic character (nonionic, anionic, cationic, amphoteric, zwitterionic), the molecular weight or the structure (linear or structured, or even crosslinked) of the water-soluble polymer.

The thickening character of these polymers may for its part be exploited in the field of enhanced oil recovery (EOR acronym for “Enhanced Oil Recovery”). The efficiency of water injection sweeping is generally improved by the addition of high molecular weight water-soluble synthetic (co)polymers. The expected and proven benefits of the use of these (co)polymers, through the “viscosification” of the injected water, are the improvement of the sweeping and the reduction of the contrast in viscosity between the fluids to control their mobility ratio within the fluid, so as to recover the oil quickly and efficiently. These (co)polymers increase the viscosity of water.

High molecular structured water-soluble polymers (branched (ramified), in the form of a star or comb) are obtained mainly in the form of water-in-oil inverse emulsion. This emulsion may then be atomized to obtain a powder. However, the powder thus obtained is fine, powdery and does not have good flow properties.

The high molecular weight linear water-soluble synthetic polymers in final powder form may be obtained by free radical polymerization according to a gel process which is efficient. However, as it is, this process does not make it possible to finely control the structure of the polymer except to obtain completely crosslinked polymers and therefore water swellable polymers (super-absorbent). It is therefore not suitable for obtaining structured water-soluble polymers of high molecular weight.

To obtain a precisely defined architecture in radical gel polymerization, one method consists in using a macroinitiator, such as a polyazo, as described in the patent application WO 2010/091333 by Nalco. The major drawback is that this type of compound is unstable and expensive. In addition, the structured polymers obtained by this gel process do not make it possible to achieve structuring rates as high as what is achievable in inverse emulsion type polymerization.

Alternatively, the atomized powders (resulting from the emulsion polymerization) may be agglomerated or mixed with other powders resulting from the gel process but this represents just as many expensive and tedious steps (see the Applicant's Japanese patent application JP 2018-216407).

For questions of logistics, transport, and the procurement of flocculants or thickeners, regardless of the intended application, the preferred physical form of these water-soluble polymers is powder (% by weight of high active material).

### DISCLOSURE OF THE INVENTION

As the world market for synthetic flocculants and thickeners is in full swing, it is necessary to have a large structural panel of water-soluble synthetic polymers of high molecular weight to meet the needs and specificities of various applications.

The term polymer denotes a homopolymer or a copolymer, which is to say, a polymer consisting of a single type of monomer (homopolymer) or a polymer consisting of at least two distinct types of monomers. A (co)polymer refers to both of these two alternatives, namely a homopolymer or a copolymer.

Faced with the difficulties in obtaining structured synthetic flocculants or thickeners in powder form, while this physical form facilitates their supply for any application, the Applicant has surprisingly discovered a new gel process for the preparation of these polymers. This method consists in introducing the structured polymer in the form of an inverse emulsion or of an dispersion in oil during the polymerization process in the gel form of a polymer.

The invention also relates to the use of the polymers of the method of the invention in the oil and gas industry, hydraulic fracturing, papermaking processes, water treatment, sludge dewatering, construction, mining, cosmetics, agriculture, textile industry and detergents.

The invention thus relates to a method for preparing a structured water-soluble polymer of weight-average molecular weight greater than 1 million Daltons and having a Huggins coefficient K_{H} greater than 0.4,

the Huggins coefficient K_{H} being measured at a polymer weight concentration of 5 g.L⁻¹, in a 0.4 N aqueous solution of sodium nitrate, at pH 3.5 and a temperature of 25° C.,

the method comprises the following successive steps:

a) Preparing a polymer, in the form of a gel, by free-radical polymerization in aqueous solution at an initiation temperature between −20° C. and +50° C. of at least one water-soluble monounsaturated ethylenic monomer,

the total weight concentration of monomer(s) in relation to the polymerization charge being between 10 and 60%;

b) Granulating the resulting polymer gel;

c) Drying the polymer gel to obtain a polymer in powder form;

d) Grinding and sifting the powder;

at least 10% by weight of water-soluble polymer, based on the total weight of the water-soluble monounsaturated ethylenic monomer or monounsaturated ethylenic monomers used in step a), being added during the polymerization step a) and optionally during the granulation step b),

the water-soluble polymer being structured and added as a water-in-oil inverse emulsion or dispersion in oil.

As used herein, the term “water-soluble polymer” means that the polymer produces an aqueous solution without insoluble particles when dissolved with stirring for 4 hours at 25° C. and with a concentration of 10 gL⁻¹ in water.

According to this invention, “molecular weight” (i.e., weight-average molecular weight) is determined by intrinsic viscosity. The intrinsic viscosity may be measured by methods known to those skilled in the art and may in particular be calculated from the values of reduced viscosity for different concentrations by a graphical method consisting of plotting the values of reduced viscosity (on the y-axis) as a function of the concentrations (on the x-axis) and by extrapolating the curve to a zero concentration. The intrinsic viscosity value is read on the y-axis or using the least squares method. Then the weight-average molecular weight may be determined by the famous Mark-Houwink equation:

[η]=KM^{α}

[η] represents the intrinsic viscosity of the polymer determined by the solution viscosity measurement method,

K represents an empirical constant,

M represents the molecular weight of the polymer,

α represents the Mark-Houwink coefficient

α and K depend on the particular polymer-solvent system

The average molecular weight of the structured water-soluble polymers obtained according to the method of the invention is greater than 1 million Daltons, advantageously greater than 2 million

Daltons and even more advantageously greater than 5 million Daltons. The average molecular weight of the structured water-soluble polymers obtained according to the method of the invention is advantageously less than 20 million Daltons, more advantageously less than 15 million Daltons, and even more advantageously less than 10 million Daltons.

The term water-soluble structured polymer excludes the polymer being linear but also that the polymer be completely crosslinked and therefore in the form of a water swellable polymer. In other words, the term, structured polymer, denotes a non-linear polymer which has side chains.

Thus, the structured polymer may be in the form of a branched polymer (ramified), in the form of a comb or in the form of a star.

The Huggins coefficient K_{H} of the water-soluble structured polymer is taken from the Huggins equation:

η_{red}=[η]+K_{H}[η]²C

With η_{red} the reduced viscosity, C the concentration by weight of polymer, and [η] the intrinsic viscosity.

Thus, the Huggins coefficient K_{H} is determined at a concentration by weight of polymer of 5 gL⁻¹, in a 0.4 N aqueous solution of sodium nitrate, at pH 3.5 and at a temperature of 25° C.

The Huggins coefficient K_{H} is a parameter indicating the morphology of the polymer in a given solvent, and at a given temperature and concentration. K_{H} increases with the branching of the polymer.

The Huggins coefficient K_{H} of the water-soluble structured polymer obtained by the method of the invention is greater than 0.4, preferably greater than 0.5 and even more preferably greater than 0.6. In general, linear polymers exhibit a Huggins coefficient of less than 0.4. On the other hand, it is not measurable for crosslinked polymers forming water swellable polymers.

Water-Soluble Polymer Structured as a Water-In-Oil Emulsion or as a Dispersion in Oil

The water-in-oil inverse emulsion comprising at least one structured water-soluble polymer added in step a) and optionally step b) of the method of the invention contains:
a hydrophilic phase comprising at least one structured water-soluble polymer;
a lipophilic phase;
at least one emulsifying agent;
optionally, a surfactant.

The lipophilic phase may be a mineral oil, a vegetable oil, a synthetic oil, or a mixture of several of these oils. Examples of mineral oil are mineral oils containing saturated hydrocarbons of the aliphatic, naphthenic, paraffinic, isoparaffinic, cycloparaffinic or naphthyl type. Examples of synthetic oil are hydrogenated polydecene or hydrogenated polyisobutene, esters such as octyl stearate or butyl oleate. Exxsol® product line from Exxon is a perfect fit.

In general, the weight ratio of hydrophilic phase to lipophilic phase in the inverse emulsion is preferably 50/50 to 90/10.

The product obtained by the process of the invention is a water-soluble polymer structured in powder form. For their subsequent use, these polymers must be easy to dissolve. In addition, the gel obtained at the end of step a) must be such that steps b) to d) take place successfully. Thus preferably, the oil of the inverse emulsion or of the dispersion has a flash point greater than 60° C. In this invention, the term “emulsifying agent” denotes an agent capable of emulsifying water in an oil and a “surfactant” is an agent capable of emulsifying an oil in water. Generally, a surfactant is considered to be a surfactant having an HLB greater than or equal to 10, and an emulsifying agent is a surfactant having an HLB strictly less than 10.

The hydrophilic-lipophilic balance (HLB) of a chemical compound is a measure of its degree of hydrophilicity or lipophilicity, determined by calculating the values of different regions of the molecule, as described by Griffin in 1949 (Griffin W C, Classification of Surface Active Agents by HLB, Journal of the Society of Cosmetic Chemists, 1949, 1, pages 311-326).

Advantageously, the inverse emulsion contains as emulsifying agent selected from the following list: polyesters having a molecular weight of between 1000 and 3000, the products of condensation between a poly(isobutenyl) succinic acid or its anhydride and a polyethylene glycol, block copolymers having a molecular weight between 2500 and 3500, such as for example those sold under the names Hypermer, sorbitan extracts, such as sorbitan monooleate or polyoleates, sorbitan isostearate or sorbitan sesquioleate, esters of polyethoxylated sorbitan, or even diethoxylated oleoketyl alcohol or tetra ethoxylated lauryl acrylate, condensation products of fatty alcohols higher than ethylene, like the reaction product of oleic alcohol with 2 ethylene oxide units; condensation products of alkylphenols and ethylene oxide, such as the reaction product of nonyl phenol with 4 units of ethylene oxide. Ethoxylated fatty amines such as Witcamide® 511, betaine products and the ethoxylated amine are also good candidates as emulsifying agents.

The inverse emulsion advantageously comprises from 0.5 to 10% by weight of at least one emulsifying agent and even more advantageously from 0.5 to 5% by weight.

A dispersion in oil comprising at least one structured water-soluble polymer essentially comprises the same ingredients as the inverse emulsion except that the hydrophilic phase (water) has been largely removed, for example by azeotropic distillation. As a result, the polymer is found in the form of particles dispersed in a lipophilic phase.

The average molecular weight of the water-soluble polymers structured in the form of a water-in-oil inverse emulsion or of an dispersion in oil is advantageously greater than 1 million Daltons, even more advantageously greater than 1.5 million Daltons and even more advantageously greater than 2 million Daltons. It is advantageously less than 20 million Daltons, more preferably less than 10 million Daltons and even more advantageously less than 7 million Daltons.

The water-soluble polymer structured in the form of a water-in-oil inverse emulsion or of a dispersion is advantageously obtained from the polymerization of monounsaturated ethylenic monomers which may be nonionic and/or anionic and/or cationic.

Advantageously, the water-soluble polymer structured in the form of a water-in-oil inverse emulsion or of a dispersion is a copolymer of nonionic monounsaturated ethylenic monomers (advantageously 10 to 100 mol %) and, where appropriate, of anionic and/or cationic monomers.

The nonionic monomers may be selected from acrylamide, methacrylamide, N,N-dimethyl acrylamide, N-vinyl formamide, N-vinyl acetamide, N-vinyl pyridine and N-vinyl pyrrolidone, acryloyl morpholine (ACMO) and diacetone acrylamide.

The anionic monomers may be selected from acrylic acid, methacrylic acid, itaconic acid, maleic acid, 2-acrylamido-2-methyl propane sulfonic acid, vinyl sulphonic acid, vinyl phosphonic acid, said anionic monomer being not salified, or partially, or totally salified.

The salts of anionic monomers (salified form) include in particular the salts of an alkaline earth metal (preferably calcium or magnesium) or of an alkali metal (preferably sodium or lithium) or of ammonium (in particular quaternary ammonium).

The cationic monomers may be selected from quaternized dimethyl aminoethyl acrylate, quaternized dimethyl aminoethyl methacrylate, dimethyl diallyl ammonium chloride, acrylamido propyl trimethyl ammonium chloride, and methacrylamide propyl trimethyl ammonium chloride. Those skilled in the art will know how to prepare the quaternized monomers, for example by means of an alkyl halide of the R—X type, R being an alkyl group and X being a halogen (in particular methyl chloride).

The structured water-soluble polymer may optionally comprise one or more hydrophobic monomers selected, in particular, from monomers of acrylamide, acrylic, vinyl, allylic or maleic type having a pendant hydrophobic function selected preferably from acrylamide derivatives such as N-alkyl acrylamides, for example, diacetone acrylamide, N-tert-butyl acrylamide, octyl acrylamide, and N,N-dialkyl acrylamides such as N,N-dihexyl acrylamide and acrylic acid derivatives such as alkyl acrylates and methacrylates.

The structured water-soluble polymer can optionally comprise a zwitterionic monomer of acrylamide, acrylic, vinyl, allylic or maleic type having an amine or quaternary ammonium function and an acid function of carboxylic, sulfonic, or phosphoric type. Mention may be made, in particular and without limitation, of derivatives of dimethyl aminoethyl acrylate, such as 2-((2-(acryloyloxy) ethyl) dimethyl ammonio) ethane-1-sulfonate, 3-((2-(acryloyloxy) ethyl) dimethyl ammonio)propane-1-sulfonate, 4-((2-(acryloyloxy) ethyl) dimethyl ammonio) butane-1-sulfonate, [2-(acryloyloxy) ethyl)] (dimethyl ammonio) acetate, derivatives of dimethyl aminoethyl methacrylate such as 2-((2-(methacryloyloxy) ethyl) dimethyl ammonio) ethane-1-sulfonate, 3-((2-(methacryloyloxy) ethyl) dimethyl ammonio)propane-1-sulfonate, 4-(((2-(methacryloyloxy) ethyl) dimethyl ammonio) butane-1-sulfonate, [2-(methacryloyloxy) ethyl)] (dimethyl ammonio) acetate, dimethyl amino propyl acrylamide derivatives such as 2-((3-acrylamidopropyl) dimethyl ammonio) ethane-1-sulfonate, 3-((3-acrylamidopropyl) dimethyl ammonio)propane-1-sulfonate, 4-((3-acrylamidopropyl) dimethyl ammonio) butane-1-sulfonate, [3-(acryloyloxy) propyl)] (dimethyl ammonio) acetate, dimethyl amino propyl methyl acrylamide derivatives such as 2-((3-methacryl amidopropyl) dimethyl ammonio) ethane-1-sulfonate, 3-((3-methacrylamidopropyl) dimethyl ammonio)propane-1-sulfonate, 4-((3-methacrylamidopropyl)) dimethyl ammonio) butane-1-sulfonate and [3-(methacryloyloxy) propyl)] (dimethyl ammonio) acetate.

Optionally, the water-soluble polymer may comprise at least one LCST or UCST group.

According to the general knowledge of those skilled in the art, an LCST group corresponds to a group whose solubility in water for a determined concentration is modified beyond a certain temperature and as a function of the salinity. This is a group exhibiting a transition temperature by heating defining its lack of affinity with the solvent medium. The lack of affinity with the solvent results in an opacification or a loss of transparency which may be due to precipitation, aggregation, gelation, or viscosification of the medium. The minimum transition temperature is called “LCST” (from the acronym “Lower Critical Solution Temperature”). For each group concentration at LCST, a heating transition temperature is observed. It is greater than the LCST which is the minimum point of the curve. Below this temperature, the (co)polymer is soluble in water, above this temperature, the (co)polymer loses its solubility in water.

According to the general knowledge of those skilled in the art, an UCST group corresponds to a group whose solubility in water for a determined concentration is modified beyond a certain temperature and as a function of the salinity. This is a group with a cooling transition temperature that defines its lack of affinity with the solvent medium. The lack of affinity with the solvent results in an opacification or a loss of transparency which may be due to precipitation, aggregation, gelation, or viscosification of the medium. The maximum transition temperature is called “UCST” (from the acronym “Upper Critical Solution Temperature”). For each group concentration at UCST, a cooling transition temperature is observed. It is greater than the LCST which is the minimum point of the curve. Above this temperature, the (co)polymer is soluble in water, below this temperature, the (co)polymer loses its solubility in water.

According to a preferred embodiment, the water-in-oil inverse emulsion or the dispersion in oil present during step a) and optionally step b) of the method of the invention advantageously contains between 10 and 70% of weight of structured water-soluble polymer.

The water-soluble polymer structured in an inverse emulsion may be composed of monomers different from those polymerized in step a). By way of example, the polymer structured in reverse emulsion can be composed of cationic and nonionic monomers and the monomers polymerized in step a) may be anionic and nonionic.

Preferably, the structured water-soluble polymer contained in the inverse emulsion or in the dispersion in oil is composed of the same monounsaturated ethylenic monomers as those polymerized in step a).

Even more preferably, the proportion of each monomer constituting the structured water-soluble polymer contained in the inverse emulsion or dispersion in oil is composed of the same proportions of monounsaturated ethylenic monomers as those polymerized in step a).

The structured water-soluble polymer contained in the water-in-oil inverse emulsion or in the dispersion in oil may be structured by at least one structural agent, which may be selected from the group comprising monomers with polyethylene unsaturation (having at least two functions unsaturated), such as, for example, vinyl, allylic, acrylic and epoxy functions, and mention may be made, for example, of methylene bis acrylamide (MBA), diallyl amine, triallyl amine, tetra allyl ammonium chloride, polyethylene glycol dimethacrylate or else by macroinitiators such as polyperoxides, polyazoics and transfer polyagents such as polymer captans polymers or alternatively hydroxy alkyl acrylates or epoxy vinyls.

The structured water-soluble polymer contained in the water-in-oil reverse emulsion or in the dispersion in oil can also be structured using techniques of controlled radical polymerization (CRP) or and more particularly of the RAFT (Reversible Addition Fragmentation Chain Transfer) type of inverse emulsion.

Preferably, the structured water-soluble polymer contained in the inverse emulsion or in the dispersion is structured with ethylenic monomers comprising at least two unsaturations.

Preferably, the Huggins coefficient of the water-soluble structured polymer of the water-in-oil inverse emulsion or of the dispersion in oil (determined under the same conditions as for the coefficient K_{H} of the polymer obtained by the process of the invention) is greater than 0.4, even more preferably than 0.5 and even more preferably than 0.6. It is measured under the conditions indicated previously in the description.

According to another preference, the water-in-oil inverse emulsion of a structured water-soluble polymer may comprise:
a hydrophilic phase comprising at least one structured water-soluble (co)polymer;
a lipophilic phase,
at least one interfacial polymer composed of at least one monomer of formula (I):

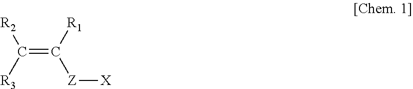

### Formula (I)

wherein,
R1, R2, R3 are independently selected from the group consisting of a hydrogen atom, a methyl group, a carboxylate group and Z—X,
Z is selected from the group comprising C(═O)—O; C(═O)—NH; OC(═O); NH—C(═O)—NH; NH—C(═O)—O; and

a saturated or unsaturated carbon chain comprising from 1 to 20 carbon atoms, substituted or unsubstituted, possibly comprising one or more heteroatoms selected from nitrogen and oxygen,
X is a group selected from alkanolamides, sorbitan esters, ethoxylated sorbitan esters, glyceryl esters, and polyglycosides; X comprising a hydrocarbon chain, saturated or unsaturated, linear, branched or cyclic, optionally aromatic.

The interfacial polymer obtained by polymerization of at least one monomer of formula (I) forms an envelope at the interface of the hydrophilic phase and the lipophilic phase.

In general, the hydrophilic phase is in the form of dispersed micrometric droplets, advantageously emulsified, in the lipophilic phase. The average size of these droplets is advantageously between 0.01 and 30 μm, more advantageously between 0.05 and 3 μm. The interfacial polymer therefore comes to be placed at the interface between the hydrophilic phase and the lipophilic phase at the level of each droplet. The interfacial polymer partially or totally envelops each of these droplets. The average droplet size is advantageously measured with a laser measuring device using conventional techniques which form part of the general knowledge of those skilled in the art. A Mastersizer type device from Malvern can be used for this purpose.

Advantageously, the interfacial polymer comprises between 0.0001 and 10%, more advantageously between 0.0001 and 5% even more advantageously from 0.0001 to 1% of monomer of formula (I), relative to the total number of monomers.

The interfacial polymer forms an envelope around the droplets forming the hydrophilic phase. In addition to the monomers mentioned above, the interfacial polymer can comprise at least one structural agent. The structural agent is advantageously selected from diacylamines or methacrylamide of diamines; acrylic esters of di, tri, or tetrahydroxy compounds; methacrylic esters of di, tri, or tetrahydroxy compounds; divinyl compounds preferably separated by an azo group; diallyl compounds preferably separated by an azo group; vinyl esters of di or trifunctional acids; allylic esters of di or trifunctional acids; methylenebisacrylamide; diallyl amine; triallyl amine; tetraallyl ammonium chloride; divinyl sulfone; polyethylene glycol dimethacrylate and diethylene glycol diallyl ether.

Gel Polymerization

The polymerization for step a) of the method of the invention is carried out by radical route. It includes polymerization by free radicals by means of UV, azo, redox or thermal initiators as well as controlled radical polymerization (CRP) techniques or more particularly using the RAFT (Reversible Addition Fragmentation Chain Transfer) type.

The polymerization charge is a solution of water-soluble monounsaturated ethylenic monomers optionally supplemented with conventional polymerization regulators before the polymerization starts. The usual polymerization regulators are, for example, sulfur compounds such as thioglycolic acid, mercapto alcohols, dodecyl mercaptan, amines such as ethanolamine, diethanolamine, morpholine and phosphites such as sodium hypophosphites. In the case of a RAFT-type polymerization, specific polymerization regulators such as those comprising a transfer group comprising the —S—CS— function, may be used. Mention may in particular be made of these compounds of the family of xanthates (—S—CS—O—), dithioesters (—S—CS-Carbon), trithiocarbonates (—S—CS—S—), or dithiocarbamates (—S—CS-Nitrogen). Among the compounds of the xanthates family, O-ethyl-S-(1-methoxy carbonyl ethyl) xanthate is widely used for its compatibility with monomers of acrylic nature.

The polymerization initiators used may be any compound which dissociates into radicals under polymerization conditions, for example: organic peroxides, hydroperoxides, hydrogen peroxide, persulfates, azo compounds, and redox catalysts. The use of water-soluble initiators is preferred. In some cases, it is advantageous to use mixtures of various polymerization initiators, for example, mixtures of redox catalysts and azo compounds.

Suitable organic peroxides and hydroperoxides are, for example, sodium or potassium peroxodisulfate, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perbuto-butylate, -ethyl hexanoate, tert-butyl per isononanoate, tert-butyl permaleate, tert-butyl perbenzoate, tert-butyl per-3,5,5-trimethylhexanoate and tert-amyl per neodecanoate

Appropriate persulphates may be selected from alkali metal persulphates such as sodium persulphate.

Suitable azo initiators are advantageously soluble in water and selected from the following list: 2,2′-azobis-(2-amidinopropane) dihydrochloride, 2,2′-azobis (N, N′-dimethylene) dihydrochloride isobutyramidine, 2-(azo (1-cyano-1-methylethyl))-2-methylpropane nitrile, 2,2′-azobis [2-(2′-dimidazolin-2-yl)propane] dihydrochloride and 4,4′ acid-azobis (4-cyanovaleric acid). Said polymerization initiators are used in usual amounts, for example in amounts of 0.001 to 2%, preferably 0.01 to 1% by weight, relative to the monomers to be polymerized.

As an oxidizing component, the redox catalysts contain at least one of the above compounds and, as a reducing component, for example ascorbic acid, glucose, sorbose, hydrogen sulfite, sulfite, thiosulfate, hyposulfite, pyrosulfite or an alkali metal, metal salts, such as in the form of iron (II) ions or silver ions or sodium hydroxy methyl sulfoxylate. The reducing component of the redox catalyst preferably used is the Mohr's salt (NH4)₂Fe(SO₄)₂, 6 H₂O. Based on the number of monomers used in the polymerization, 5×10⁻⁶ to 1 mole % of the reducing component of the redox catalyst system and 5×10⁻⁵ to 2 moles % of the oxidizing component of the redox catalyst can, as an example, be used. Instead of the oxidizing component of the redox catalyst, one or more water soluble azo initiators can also be used.

For step a) of the method of the invention, the total concentration by weight of free monomers relative to the polymerization charge is between 10 and 60%, advantageously between 20 and 55% and even more advantageously between 25 and 50%.

For step a) of this process, the monomers and the various polymerization additives are dissolved, for example, in vessels with stirring in the aqueous medium to be polymerized. This solution, also called the charge to be polymerized, is adjusted to an initiation temperature of between −20° C. to 50° C. Advantageously, this initiation temperature is adjusted between −5° C. and 30° C. and even more advantageously between 0 and 20° C.

When the water-soluble polymer structured in the form of a water-in-oil inverse emulsion or of a dispersion in oil is added during step a) of the method of the invention, it may be added during the dissolution of the polymerization monomers and additives. Thus, it is mixed into the polymerization charge by means of a stirring paddle for the purpose of finely dispersing the emulsion or the inverse dispersion in the polymerization charge. It is also possible to pass the mixture through a homogenizer of the rotor, rotor/stator type.

Another means of adding the structured polymer emulsion or dispersion to the polymerization charge is to inject the emulsion into the polymerization charge going to the polymerization reactor, with a static mixer inserted between the point of injection of the emulsion or dispersion and the reactor.

In order to remove the residual oxygen from the polymerization charge (whether or not with additives to the structured polymer in the form of an inverse emulsion or of a dispersion in oil), an inert gas is usually passed through it. Suitable inert gases for this are, for example, nitrogen, carbon dioxide or rare gases such as neon or helium. The polymerization is carried out in the absence of oxygen, by introducing the initiators in the appropriate order, known to those skilled in the art, into the solution to be polymerized. The initiators are introduced either in soluble form in aqueous medium or, if desired, in the form of a solution in an organic solvent.

The polymerization may be carried out batchwise or continuously. In a batch procedure, a reactor is filled with a monomer solution and then with an initiator solution. As soon as the polymerization begins, the reaction mixture heats up depending on the starting conditions selected, such as the concentration of the monomers in the aqueous solution and the nature of the monomers. Due to the heat of polymerization released, the temperature of the reaction mixture rises, for example, from 30 to 180° C., preferably from 40° C. to 130° C. The polymerization may be carried out at normal pressure, under reduced pressure or even at high pressure. Working at elevated pressure may be advantageous in cases where the maximum temperature expected in the polymerization is above the boiling point of the mixture of solvents used. On the other hand, it may be advantageous, in particular during the preparation of products of very high molecular weight, to lower the maximum temperature by means of cooling, for example with a cooling fluid. In most cases, the reactor is jacketed so that the reaction mixture may be cooled or heated as needed. Once the polymerization reaction is complete, the obtained polymer gel may be quickly cooled, for example by cooling the wall of the reactor.

At the end of the reaction, the product resulting from the polymerization is a hydrated gel so viscous that it is self-supporting (thus a cube of gel of 2.5 cm per side substantially maintains its shape when placed on a flat surface). The gel thus obtained is a viscoelastic gel.

Note that when the reaction is carried out in a reactor, in order to facilitate the discharge of the gel at the end of the reaction, the reactor is advantageously in inverted conical tubular form (cone downwards) in order to discharge the gel downwards by application of an inert gas or air pressure at the surface of the gel or in the form of a rocker in order to discharge the mass of gel by rocking the reactor.

Step b) of the method of the invention consists in granulating the water-soluble polymer gel obtained in step a). Granulation consists of cutting the gel into small pieces. Advantageously, the average size of these pieces of gel is less than 1 cm, more advantageously it is between 4 and 8 mm. Those skilled in the art will know how to choose the means suitable for optimum granulation. When the inverse emulsion or the dispersion in oil of water-soluble structured polymer is added during the granulation step b) of the method of the invention, it may be added by spraying to the surface of the gel pieces.

Advantageously, between 0.1% and 2.0% of surfactant in liquid form may be sprayed during step b) (% by weight relative to the total weight of the free monomers used in step a)).

Step c) of the process consists in drying the polymer. The choice of drying means is routine for those skilled in the art. Industrially, the drying is advantageously carried out by a fluidized bed or rotor dryer, using air heated to a temperature between 70° C. and 200° C., the air temperature being a function of the nature of the product as well as the drying time applied. After drying, the water-soluble polymer is physically in powder form.

For step d) of the method, the powder is crushed and sifted. The grinding step involves breaking up the large polymer particles into smaller sized particles. This may be done by shearing or by mechanical crushing of the particle between two hard surfaces. Different types of equipment known to those skilled in the art may be used for this purpose. For example, we may reference mills with rotors, where one crushes the particle assisted by the rotating part on a compression blade or the roller mill, where the particle is crushed between two rotating cylinders. The purpose of sifting is to then remove, depending on the specifications, the medium-sized particles that are too small or too large.

Advantageously, between 0.1% and 2.0% of surfactant in solid form may be added during step d) of the method (% by weight relative to the total weight of the free monomers used in step a)).

The method of the invention implies that at least 10% by weight, relative to the total weight of the free monomers used, of water-soluble polymer in the form of a water-in-oil inverse emulsion or of a dispersion in oil, containing at least less one structured water-soluble polymer, are added during the polymerization step a) and optionally during the granulation step b). The free monomers by definition have not yet been polymerized. Therefore, these do not include the monomers of the structured polymer in the form of an inverse emulsion or of a dispersion in oil.

Preferably, between 10 and 50% by weight, based on the total weight of free monomers involved, of water-soluble polymer in the form of a water-in-oil inverse emulsion or dispersion in oil, containing at least one structured water-soluble polymer, is added during the polymerization step a) and optionally during the granulation step b).

Even more preferably, between 10 and 50% by weight, based on the total weight of the free monomers involved, of water-soluble polymer in the form of a water-in-oil inverse emulsion or dispersion in oil, containing at least one structured water-soluble polymer, are added in a proportion of between ⅔ and ¾ during the polymerization step a) and of between ¼ and ⅓ during the granulation step b).

According to a preferred embodiment, between 10 and 30 wt. %, based on the total weight of the free monomers involved, of water-soluble polymer in the form of a water-in-oil inverse emulsion or dispersion in oil, containing at least one structured water-soluble polymer, is added during the polymerization step a).

Advantageously, for the polymerization step a), at least one nonionic water-soluble monounsaturated ethylenic monomer (advantageously between 10 and 100 mol %) and, where appropriate, at least one anionic or cationic water-soluble unsaturated ethylenic monomer are polymerized.

The nonionic, anionic, or cationic monomers are preferably selected from the lists given above for polymers in inverse emulsion or in oil dispersion.

According to another preference, during the polymerization in step a) of the method of the invention, the Brookfield viscosity of the polymerization charge at the polymerization temperature is less than 100 centipoises (Brookfield modulus: LV1, speed of rotation: 60 rpm⁻¹). This viscosity corresponds to the viscosity measured after addition and homogenization of the structured polymer in the form of water-in-oil inverse emulsion or of an aqueous dispersion in the polymerization charge.

According to a preferred embodiment, the method of the invention consists for step a) of polymerizing by the radical route, by means of redox initiators and azo compounds, at an initiation temperature of between 0 and 20° C. at least one monounsaturated ethylenic monomer soluble in aqueous solution, the concentration by total weight of monomer relative to the polymerization charge being between 25 and 50%, in the presence of 20 to 30% by weight, relative to the total weight of the free monomers involved, of an inverse emulsion containing between 30 and 60% by weight of a copolymer composed of acrylamide and 40 to 90 mol % of dimethyl amino ethyl acrylate quaternized with methyl chloride, structured with less than 0.05% of methylenebisacrylamide, of which the Huggins coefficient, at a concentration by weight of polymer of 5 gL⁻¹ in deionized water and at a temperature of 25° C., is greater than 0.4, and the Brookfield viscosity of the polymerization charge at the temperature of polymerization is less than 100 centipoise (Brookfield modulus: LV1, speed of rotation: 60 rpm⁻¹) and for step b) to granulate the gel thus obtained in the presence of 5 to 10% by weight of this polymer in the form of an inverse emulsion.

A final aspect of the invention concerns the use of polymers obtained according to the method of the invention in the oil and gas industry, hydraulic fracturing, papermaking processes, water treatment, sludge dewatering, construction, mining, cosmetics, agriculture, textile industry and detergents.

The invention and the advantages which result therefrom will emerge more clearly from the following exemplary embodiments.

### EXAMPLES

### Example 1: Gel Synthesis of a Quaternized Acrylamide/Dimethyl Amino Ethyl Acrylate Copolymer (Adame Quat) by Adding to the Polymerization Charge 20% by Weight of Structured Polymer in Reverse Emulsion Form

In a 2 L beaker, an aqueous charge comprising 113 g of acrylamide at 50% by weight in water, 773 g of Adame Quat (Adame Quat=dimethyl amino ethyl acrylate quaternized with methyl chloride) at 80% by weight in water and 177 g of water is prepared at room temperature, then the pH is adjusted between 3 and 4 using phosphoric acid. This charge is then cooled to 10° C., then placed in a Dewar. 1.5 g of azobisisobutyronitrile are introduced into the charge as well as 420 g of an inverse emulsion (EM1) containing 41% by weight of an acrylamide/Adame Quat copolymer (20/80 mol %), the proportion of aqueous phase/oily phase synthetic (Exxsol D100) being 70/30. The copolymer of the inverse emulsion is crosslinked with MBA and has a Huggins coefficient (at a polymer concentration by weight of 5 gL⁻¹, in a 0.4 N aqueous solution of sodium nitrate, at pH 3.5 and at a temperature of 25° C.) of 0.8.

The homogenization of the charge is carried out using a hand mixer at a speed of 500 rpm for 20 s. This charge comprising the monomers and the branched polymer in the form of an inverse emulsion is then degassed with nitrogen bubbling for 20 minutes. The viscosity measured after degassing is 82 cP (Brookfield modulus: LV1, speed of rotation: 60 rpm⁻¹). 1.3×10⁻³ mole % of sodium hypophosphite is then added to the charge, expressed relative to the total amount of monomers involved, then the reaction is initiated by successive additions of 3.2×10⁻³ mole % of sodium persulfate then 1.9×10⁻³ mole % of Mohr's salt. The reaction time is 45 min, for a final temperature of 80° C. The polymer obtained is in the form of a gel having a texture allowing it to be granulated and then to be dried in an air flow at 70° C. for 60 min. The dry polymer grains are then ground in order to obtain a particle size of less than 1.7 mm. The product obtained, which is 100% water soluble, has a weight average molecular weight of 1.9 million Daltons and a K_{H} (at a polymer weight concentration of 5 gL⁻¹, in an aqueous solution of 0.4 N sodium nitrate, at pH 3.5 and at a temperature of 25° C.) of 0.69.

### Example 2: Synthesis by RAFT-Type Gel Route of an Acrylamide/Adame Quat Copolymer by Adding to the Polymerization Charge 20% by Weight of Structured Polymer in the Form of an Inverse Emulsion

In a 2 L beaker, an aqueous charge comprising 113 g of acrylamide at 50% by weight in water, 773 g of Adame Quat at 80% by weight in water and 177 g of water is prepared at room temperature, then the pH is adjusted between 3 and 4 using phosphoric acid. This charge is then cooled to 10° C., then placed in a Dewar. 1.5 g of azobisisobutyronitrile (AIBN) are introduced into the charge as well as 420 g of the inverse emulsion (EM1) used in Example 1. The homogenization of the charge is carried out using a hand mixer at a speed of 500 rpm for 20 seconds. This charge comprising the monomers and the branched polymer in the form of an inverse emulsion is then degassed with nitrogen bubbling for 20 minutes. The viscosity measured after degassing is 82 cP (Brookfield modulus: LV1, speed of rotation: 60 rpm⁻¹). 5.2×10⁻³ mole % of sodium hypophosphite is then added to the charge, expressed relative to the total amount of monomers involved, 5.2×10−4 mol % of O-ethyl-S-(1-methoxy carbonyl ethyl) xanthate (RAFT transfer agent), then the reaction is initiated by successive additions of 3.2×10−3 mole % of sodium persulfate then 1.9×10−3 mole % of Mohr's salt. The reaction time is 60 min, for a final temperature of 80° C. The polymer obtained is in the form of a gel having a texture allowing it to be granulated and then to be dried in an air flow at 70° C. for 60 minutes. The dry polymer grains are then ground in order to obtain a particle size of less than 1.7 mm. The product obtained, which is 100% water soluble, has a weight average molecular weight of 2.1 million Daltons and a K_{H} (at a polymer weight concentration of 5 gL⁻¹, in an aqueous solution of 0.4 N sodium nitrate, at pH 3.5 and at a temperature of 25° C.) of 0.73.

### Example 3 (Counter-Example): Gel Synthesis of a Branched Acrylamide/Adame Quat Copolymer Using N,N′-Methylenebis(Acrylamide) (MBA)

In a 2 L beaker, an aqueous charge comprising 126 g of acrylamide at 50% by weight in water, 858 g of Adame Quat at 80% by weight in water and 534 g of water is prepared at room temperature, then the pH is adjusted between 3 and 4 using phosphoric acid. This charge is then cooled to 0° C., then placed in a Dewar. 1.5 g of azobisisobutyronitrile are introduced into the charge which is degassed under nitrogen bubbling for 20 minutes. During bubbling, 2.1×10⁻² mol % of sodium hypophosphite and 6.6×10⁻³ mol % of MBA are introduced, based on the total amount of monomers involved. The reaction is then initiated at a temperature of 0° C. by successively adding, always expressed with respect to the total amount of monomers involved, 3.4×10⁻³ mol % of sodium persulfate and 3.4×10⁻⁴ mol % of Mohr's salt. The reaction time is 30 min, for a final temperature of 70° C. The polymer obtained is in the form of a gel having a texture allowing it to be granulated and then to be dried in an air flow at 70° C. for 60 minutes. The dry polymer grains are then ground in order to obtain a particle size of less than 1.7 mm. The product obtained, which is 100% water soluble, has a weight-average molecular weight of 2.4 million Daltons and a K_{H} (at a polymer weight concentration of 5 gL⁻¹, in an aqueous solution of 0.4 N sodium nitrate, at pH 3.5 and at a temperature of 25° C.) of 0.24.

When the structured polymers are obtained by the method of the invention (examples 1 and 2) their K_{H} is higher than 0.4, whereas by directly adding the structuring agent (MBA) to the charge of a gel polymerization, the K_{H} remains lower than 0.3 (example 3: counter-example).

1. A method for preparing a structured water-soluble polymer of weight-average molecular weight greater than 1 million Daltons and having a Huggins coefficient K_{H} greater than 0.4,
the Huggins coefficient K_{H} being measured at a polymer weight concentration of 5 g.L⁻¹, in a 0.4 N aqueous solution of sodium nitrate, at pH 3.5 and a temperature of 25° C., the method comprising the following successive steps:
a) preparing a polymer, in the form of a gel, by free-radical polymerization in aqueous solution at an initiation temperature between −20° C. and +50° C. of at least one water-soluble monounsaturated ethylenic monomer,
the total weight concentration of monomer(s) in relation to polymerization charge being between 10 and 60%;
b) granulating the resulting polymer gel;
c) drying the polymer gel to obtain a polymer in powder form;
d) grinding and sifting the powder;
at least 10% by weight of water-soluble polymer, based on the total weight of the water-soluble monounsaturated ethylenic monomer or monounsaturated ethylenic monomers used in step a), being added during the polymerization step a) and optionally during the granulation step b), the water-soluble polymer being structured and added as a water-in-oil inverse emulsion or dispersion in oil.

2. The method according to claim 1, wherein between 10 and 50% by weight, based on the total weight of free monomers involved, of water-soluble polymer in the form of a water-in-oil inverse emulsion or dispersion in oil, containing at least one structured water-soluble polymer, is added during the polymerization step a) and optionally during the granulation step b).

3. The method according to claim 1, wherein between 10 and 50% by weight, based on the total weight of the free monomers involved, of water-soluble polymer in the form of a water-in-oil inverse emulsion or in dispersion oil, containing at least one structured water-soluble polymer, are added in a proportion of between ⅔ and ¾ during the polymerization step a) and of between ¼ and ⅓ during the granulation step b).

4. The method according to claim 1, wherein between 10 and 30%, based on the total weight of the free monomers involved, of water-soluble polymer in the form of a water-in-oil inverse emulsion or dispersion in oil, containing at least one structured water-soluble polymer, is added during the polymerization step a).

5. The method according to claim 1, wherein the Brookfield viscosity of the polymerization charge at the polymerization temperature is less than 100 centipoise (Brookfield modulus: LV1, speed of rotation: 60 rpm⁻¹).

6. The method according to claim 1, wherein the Huggins coefficient of the water-soluble structured polymer of the water-in-oil inverse emulsion or of the dispersion in oil at a polymer weight concentration of 5 g L⁻¹ in a 0.4 N aqueous solution of sodium nitrate at pH 3.5 and a temperature of 25° C. is greater than 0.4.

7. The method according to claim 1, wherein step a) involves the polymerization of at least one nonionic water-soluble monounsaturated ethylenic monomer and at least one anionic or cationic water-soluble unsaturated ethylenic monomer.

8. The method according to claim 7, wherein the at least one nonionic monomers is selected from acrylamide, methacrylamide, N,N-dimethylacrylamide, N-vinyl formamide, N-vinyl acetamide, N-vinyl pyridine and N-vinylpyrrolidone, acryloyl morpholine (ACMO) and diacetone acrylamide.

9. The method according to claim 7, wherein the anionic monomer is selected from acrylic acid, methacrylic acid, itaconic acid, maleic acid, 2-acrylamido-2-methyl propane sulfonic acid, vinylsulphonic acid, and vinyl phosphonic acid, said anionic monomer being not salified, or partially, or totally salified.

10. The method according to claim 7, wherein the cationic monomer is selected from quaternized dimethyl amino ethyl acrylate, quaternized dimethyl amino ethyl methacrylate, dimethyl diallyl ammonium chloride, acrylamido propyl trimethyl ammonium chloride, and methacryl amido propyl trimethyl ammonium chloride.

11. The method according to claim 1, wherein the water-in-oil inverse emulsion or the dispersion in oil contains between 10 and 70% by weight of structured water-soluble polymer.

12. The method according to claim 1, wherein the structured water-soluble polymer contained in the inverse emulsion or in the dispersion in oil is composed of the same monounsaturated ethylenic monomers as those polymerized in step a).

13. The method according to claim 12, wherein the proportion of each monomer constituting the structured water-soluble polymer contained in the inverse emulsion or dispersion in oil is composed of the same proportions of monounsaturated ethylenic monomers as those polymerized in step a).

14. The method according to claim 1, wherein the structured water-soluble polymer contained in the inverse emulsion or the dispersion is structured with ethylenic monomers having at least two unsaturations.

15. The method according to claim 1, wherein the oil in the inverse emulsion or the dispersion has a flash point above 60° C.

16. The method according to claim 1, wherein the water-in-oil inverse emulsion of the structured water-soluble polymer comprises:
a hydrophilic phase comprising at least one structured water-soluble (co)polymer;
a lipophilic phase;
at least one interfacial polymer composed of at least one monomer of formula (I): 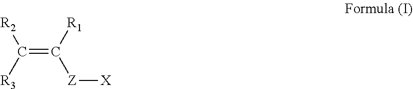
wherein,
R1, R2, R3 are independently selected from the group consisting of a hydrogen atom, a methyl group, a carboxylate group and Z—X,
Z is selected from the group consisting of C(═O)—O; C(═O)—NH; O—C(═O); NH—C(═O)—NH; NH—C(═O)—O; and a saturated or unsaturated carbon chain comprising from 1 to 20 carbon atoms, substituted or unsubstituted, possibly comprising one or more heteroatoms chosen from nitrogen and oxygen,
X is a group chosen from alkanolamides, sorbitan esters, ethoxylated sorbitan esters, glyceryl esters, and polyglycosides; X comprising a hydrocarbon chain, saturated or unsaturated, linear, branched or cyclic, optionally aromatic.

17. The method according to claim 1, consisting for step a) of polymerizing by the radical route, by means of redox initiators and azo compounds, at an initiation temperature of between 0 and 20° C. at least one monounsaturated ethylenic monomer soluble in aqueous solution, the concentration by total weight of monomer relative to the polymerization charge being between 25 and 50%, in the presence of 20 to 30% by weight, relative to the total weight of the free monomers involved, of an inverse emulsion containing between 30 and 60% by weight of a copolymer composed of acrylamide and 40 to 90 mol % of dimethylaminoethyl acrylate quaternized with methyl chloride, structured with less than 0.05% of methylenebisacrylamide, of which the Huggins coefficient, at a concentration by weight of polymer of 5 gL⁻¹ in deionized water and at a temperature of 25° C., is greater than 0.4, and the Brookfield viscosity of the polymerization charge at the temperature of polymerization being less than 100 centipoise (Brookfield modulus: LV1, speed of rotation: 60 rpm⁻¹) and for step b) to granulate the gel thus obtained in the presence of 5 to 10% by weight of this polymer in the form of an inverse emulsion.

18. The method according to claim 2, wherein the Brookfield viscosity of the polymerization charge at the polymerization temperature is less than 100 centipoise (Brookfield modulus: LV1, speed of rotation: 60 rpm⁻¹).

19. The method according to claim 18, wherein the Huggins coefficient of the water-soluble structured polymer of the water-in-oil inverse emulsion or of the dispersion in oil at a polymer weight concentration of 5 g L⁻¹ in a 0.4 N aqueous solution of sodium nitrate at pH 3.5 and a temperature of 25° C. is greater than 0.4.

20. The method according to claim 19, wherein step a) involves the polymerization of at least one nonionic water-soluble monounsaturated ethylenic monomer and at least one anionic or cationic water-soluble unsaturated ethylenic monomer.
